(19) United States
(12) Patent Application Publication
(10) Pub. No.: US 2014/0258994 A1
(43) Pub. Date: Sep. 11, 2014

(54) ADAPTIVE THREADED VIRTUAL PROCESSOR

(71) Applicant: Terrence V. Powderly, Malvern, PA (US)

(72) Inventor: Terrence V. Powderly, Malvern, PA (US)

(73) Assignee: Unisys Corporation, Blue Bell, PA (US)

(21) Appl. No.: 13/934,370

(22) Filed: Jul. 3, 2013

Related U.S. Application Data
(60) Provisional application No. 61/773,268, filed on Mar. 6, 2013.

(51) Int. Cl. G06F 9/455

(52) U.S. Cl. CPC G06F 9/45508
USPC 717/139

(57) ABSTRACT

Systems and methods for generating and executing a translated code stream corresponding to a translation of a plurality of non-native operators are disclosed. One method includes, during interpreted execution of non-native code encountered by an interpreter, for a non-native operator included in a code sequence, selecting one or more native operators useable to perform a task defined at least in part by the non-native operator. The one or more native operators are further selected based on a data type of non-native operands associated with the non-native operator. The method also includes storing the one or more native operators in a shadow code array in a memory of the computing system, the shadow code array associated with the processing module. The method further includes executing the code sequence from the shadow code array, including executing the one or more native operators, thereby performing the task.

### TECHNICAL FIELD

The present application relates generally to management of computing resources, and in particular to an adaptive threaded virtual processor.

### BACKGROUND

A computing system generally includes a central processing unit that is configured to execute program instructions which are ordered and arranged to execute various tasks. Each central processing unit has a predefined set of instructions capable of execution on that system, referred to as an instruction set. The instruction set executable by a central processing unit defines the instruction set architecture of that central processing unit.

Often, it is desirable to run software written for a particular instruction set architecture on a computing system that has a different, and incompatible, instruction set architecture. To do so, the software must be translated from the instruction set in which it is written to an instruction set compatible with the target central processing unit. This can be done at least two different ways. First, if source code is available, it can be recompiled onto the new instruction set architecture using a compiler specific to that architecture. Second, if source code is not available or if for some other reason the binary program is the desired source from which operation is to be derived, the software can be translated onto the new instruction set architecture by translating the binary program onto the new instruction set architecture on an instruction-by-instruction basis.

In comparing these two approaches, it is noted that use of source code can render a much more efficient translation to the new instruction set architecture, because efficiencies in a particular instruction set can be exploited based on the structure of the overall software. However, a recompiled source code translation is not easily used in realtime, and cannot be used if source code is unavailable. In contrast, the binary translation arrangement is generally resource intensive and does not result in execution of the most efficient translation possible. This is because each binary instruction in one language is generally translated into a binary instruction in the target language, and designed for the target architecture. That binary instruction may be a different number of bits, bytes, or words long, or the particular byte and/or word length may differ across the architectures. Furthermore, the binary instruction may be byte-ordered differently in the source and target architectures, for example being big-endian or little-endian.

To accomplish execution of binary code on a non-native instruction set architecture, the binary code is often translated using an emulator designed for a target instruction set architecture. An emulator, also referred to herein as an interpreter, is a set of software modules that is configured to execute binary code from its native format in a way that is recognizable on a target computing system executing the target instruction set architecture. This binary code, referred to herein as emulation mode code, is parsed by the emulator to detect operators and other information that are then translated to be executed in a manner recognizable on the target computing system. For example, if a target system operates using a little-endian, eight byte code word and emulation mode code is written using a big-endian, six byte code word, the emulator would look at a current and next eight byte code word in realtime, to detect one or more operators of six-byte length (e.g., in case they overlap across the eight-byte codeword) in reverse order; the emulator would then determine corresponding instructions in the target instruction set architecture that would accomplish the same functionality as the native instruction, and execute that instruction.

This code interpretation, or emulation, allows for realtime translation and execution on an operator-by-operator basis, but is inefficient. This is for a variety of reasons. For example, emulation may not take into account the available operators in the target system that could more efficiently execute the code when it is translated. Additionally, emulation generally would require either pre-execution translation of non-native code, or would require some level of runtime translation. Although pre-execution translation allows an emulation system to analyze the non-native, emulation mode code to obtain such pre-execution translation is difficult to accomplish, since (1) it can be difficult to know exactly the portions of the emulated mode code that will be executed, and (2) translation of that code can take significant time. This is further complicated by the fact that, in some instruction set architectures, operands cannot be directly translated to operands of a different instruction set architecture without some knowledge of the data types involved in the operands that are acted upon for the particular execution instance of the instruction. Where an emulation mode operator does not distinguish among data types but the translated code does have different operators for different data types, either the translation is limited to only general purpose operators (typically the least efficient operators available), or some amount of runtime variability may need to be accounted for. Finally, either complete runtime or complete pre-runtime translation have the disadvantage of forcing all translation through an emulator, which is typically maintained in a single execution thread, and is therefore inefficiently executed on modern, multi-threaded, massively-parallel computing systems.

For these and other reasons, improvements are desirable.

### SUMMARY

In accordance with the following disclosure, the above and other issues are addressed by the following:

In a first aspect, a method for generating and executing a translated code stream corresponding to a translation of a plurality of non-native operators are disclosed. The method includes, during interpreted execution of non-native code encountered by an interpreter, for a non-native operator included in a code sequence, selecting one or more native operators useable to perform a task defined at least in part by the non-native operator. The one or more native operators are further selected based on a data type of non-native operands associated with the non-native operator. The method also includes storing the one or more native operators in a shadow code array in a memory of the computing system, the shadow code array associated with the processing module. The method further includes executing the code sequence from the shadow code array, including executing the one or more native operators, thereby performing the task.

In a second aspect, an adaptive threaded virtual processing system is disclosed. The system includes a processing unit and a memory communicatively connected to the processing unit. The memory stores non-native instructions and data, a shadow code array, and an interpreter. The interpreter is configured to, when executed by the processing unit, cause a computing system to perform a method of generating and executing a translated code stream. The method includes, during interpreted execution of non-native code, for a non-native operator included in a code sequence of the non-native instructions encountered by an interpreter, selecting one or more native operators useable to perform a task defined at least in part by the non-native operator. The one or more native operators are further selected based on a data type of non-native operands associated with the non-native operator. The method further includes storing the one or more native operators in the shadow code array, and executing the code sequence from the shadow code array, including executing the one or more native operators, thereby performing the task.

In a third aspect, a computer-readable storage medium having computer-executable instructions stored thereon is disclosed. When executed by a computing system, the computer-executable instructions cause the computing system to perform a method of generating and executing a translated code stream corresponding to a translation of a plurality of non-native operators. The method includes, during interpreted execution of non-native code encountered by an operator interpretation phase of an interpreter, and for each non-native operator included in a code sequence, selecting one or more native operators useable to perform a task defined by the non-native operator. The one or more native operators are further selected based on a data type of non-native operands associated with the non-native operator. The method also includes storing the one or more native operators in a shadow code array in a memory of the computing system, the shadow code array associated with a processor of the computing system. The method further includes executing the code sequence from the shadow code array via the processor by executing the one or more native operators, thereby performing the task.

### BRIEF DESCRIPTION OF THE DRAWINGS

FIG. 1 is a schematic illustration of a plurality of computing systems operating using incompatible instruction set architectures;

FIG. 2 is a schematic illustration of a target computing system executing emulated code derived from a non-native code stream, according to a possible embodiment of the present disclosure;

FIG. 3 is a block diagram of an example embodiment of an adaptive threaded virtual processing system, according to a possible embodiment of the present disclosure;

FIG. 4 is a schematic illustration of an example computing system in which aspects of the present disclosure can be implemented;

FIG. 5 is a flowchart of methods and systems for generating and executing a translated code stream corresponding to a translation of a plurality of non-native operators, according to an example embodiment;

FIG. 6 is a flowchart of methods and systems for adaptively generating native code in a shadow code array for execution, within the methods and systems of FIG. 5, above, according to an example embodiment;

FIG. 7 is a flowchart of methods and systems for determining native code to be executed based on a non-native code sequence, according to an example embodiment;

FIG. 8 is an illustration of memory containing non-native and native code, illustrating translation of a portion of the non-native code, according to an example embodiment;

FIG. 9 is an illustration of adaptive translation of a non-native code sequence to native code, according to an example implementation; and

FIG. 10 is a further illustration of adaptive translation of a non-native code sequence to native code, according to an example implementation.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to an adaptive threaded virtual processor useable to execute non-native code streams. In particular, the present disclosure describes methods and systems for virtualizing and executing a non-native code stream on a computing system having a native instruction set architecture, using an arrangement by which non-native instructions are interpreted as native instructions, and runtime context as to the data on which the instructions operate informs the system as to the types of instructions to be executed. In the context of the present disclosure, non-native instructions that are in a code stream to be executed are parsed and analyzed to determine efficient native processes by which to execute corresponding tasks using native instructions.

The methods and systems of the present disclosure provide improved performance within an emulated computing environment, in particular by providing for adaptive interpretation and execution of instructions at least in part during runtime of the non-native code stream. In some embodiments of the present disclosure, each non-native operator included in an execution code stream is translated for storage in a shadow memory, which stores translated code sequences that are created as a particular non-native program (e.g., of emulation mode instructions) is encountered and executed. One or more assumptions regarding the non-native code stream are made to form the translation to shadow memory, thereby assuming a commonly-used and efficient version of an operator for use in the translated, native code stream until a counterexample is encountered. At such time, a more general purpose version of the operator could be selected for use in the shadow memory for subsequent execution of the code. Since shadow memories are allocated on a per-processor (logical) basis, and because individual logical processing cores are often scheduled to repeatedly perform the same tasks within a computing system by associated scheduling software/hardware, a code sequence will generally be repeated on similar data, thereby allowing each processing core to individually adapt to the code allocated thereto. In addition, the methods and systems of the present disclosure effectively decouple interpretation of non-native instructions from parsing and execution of native instructions. This assists in ensuring that the non-native instructions are only translated at the time they are reached in an execution sequence, and then only to the extent that is required by each processor to form the shadow code arrays that include native instructions corresponding to the non-native instructions that are found in code. Accordingly, the adaptive systems discussed herein provide for improved efficiency as compared to existing virtualized execution arrangements.

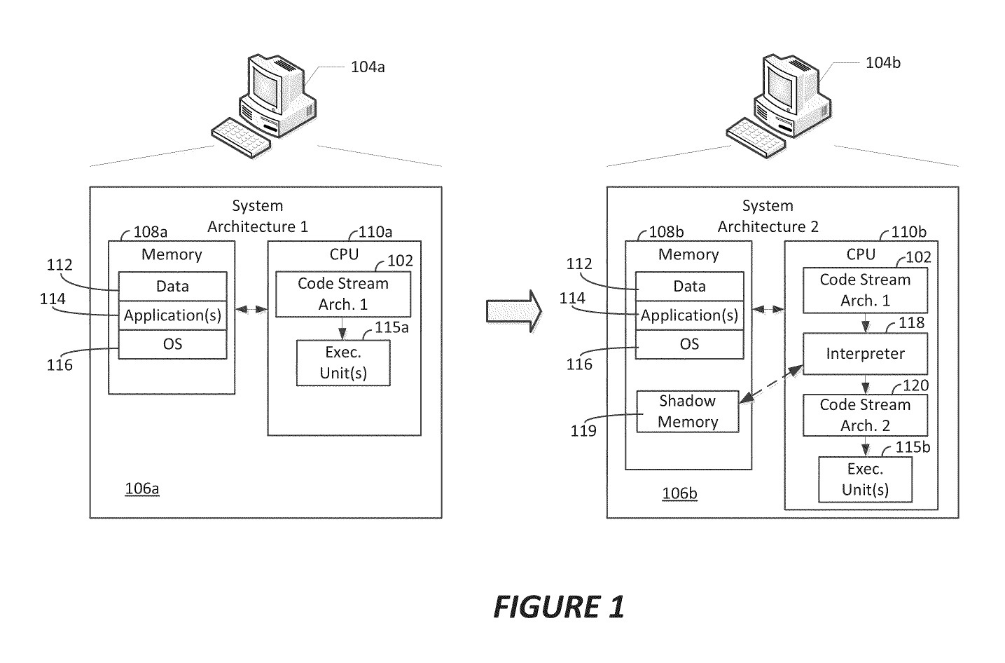

Referring now to FIG. 1, a schematic illustration of a plurality of computing systems operating using incompatible instruction set architectures is shown. The illustration shown in FIG. 1 is intended to illustrate execution of a code stream 102 on two computing systems 104a-b using different and incompatible instruction set architectures. In other words, while code stream 102 executes natively on the hardware provided as part of computing system 104a, it is non-native to the computing system 104b, meaning that computing system operates using a different set of instructions, and cannot natively execute those instructions, or operators, included in the code stream.

In further specific detail regarding this distinction between native and non-native execution of a code stream, computing system 104a has a first system architecture 106a, and computing system 104b has a second system architecture 106b. Computing system 104a includes a memory 108a and processing unit 110a, while computing system 104b has a memory 108b and processing unit 110b. Typically, in systems having a different system architecture, different memory address sizes and different instruction lengths may be employed, as well as different sets of registers or other resources within the processing units 110a-b. Additionally, optionally a first instruction set architecture can utilize a different logical or bit layout (e.g., big-endian, little-endian, signed/unsigned, floating point definition, etc.)

In the example shown, each memory 108 includes a variety of different types of stored information, including data 112, applications 114, and an operating system 116. On computing system 104a, the operating system executes natively using the system architecture 106a, and controls operation of the applications 114 and access to data 112. The resulting code stream 102 represents a sequence of binary operations and data that are parsed and executed on the computing system 104a, within one or more execution units 115a of the processing unit 110a.

In contrast, the same data 112, applications 114, and operating system 116 can be stored in memory 108b and can form code stream 102, but that code stream cannot directly be executed by the processing unit 110b. Rather, the code stream 102 is passed to an emulator 118, which converts the code stream 102, which is non-native with respect to system architecture 106b, to a second code stream 120 which is native to that system architecture. That second code stream 120 can then be executed on execution units 115b of the processing unit 110b.

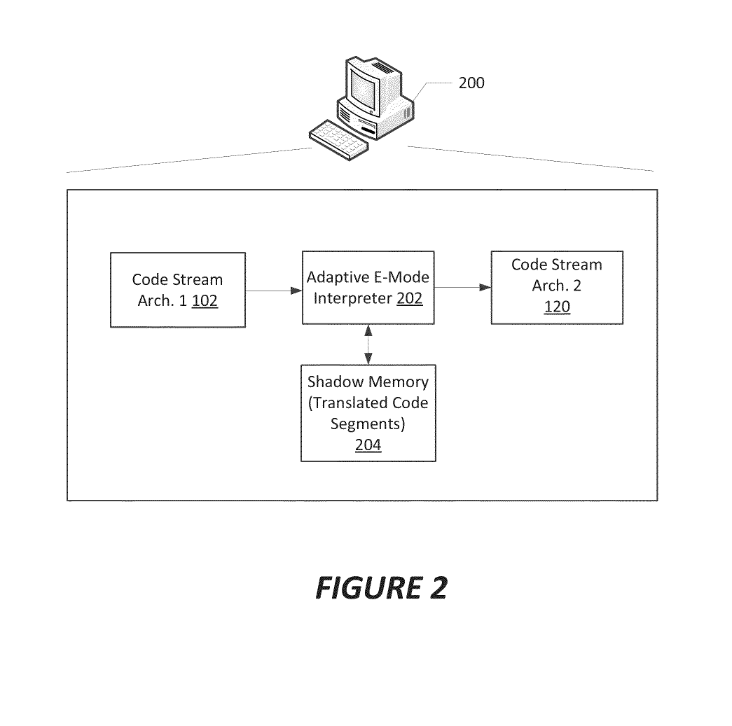

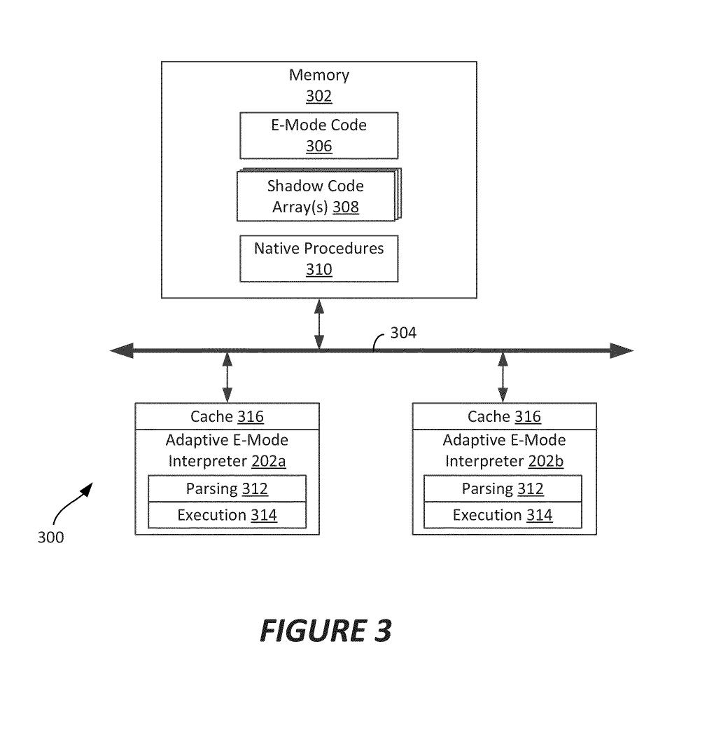

As further discussed below in connection with FIGS. 2-10, it is noted that the interpreter 118 can be constructed as an adaptive interpreter, and can create and manage a shadow memory 119 in the memory 108b. The shadow memory 119 is generally a memory space within the same system (or partition) as the non-native data, applications, and operating system 116, but can be used to cache for subsequent access and re-execution areas of that non-native memory. Details regarding such features are provided below in connection with FIGS. 3 and 5-10.

Although depicted as occurring within the processing units 110a-b, it is understood that the code streams 102, 120 can be generated and executed in a variety of ways. Generally, code stream 102 is directly executed in processing unit 110a, in that the code stream 102 is directly machine-readable from memory 108a. However, as further discussed below, in computing system 104b, code stream 102 can be translated, for example using the adaptive interpreter 118 to create a shadow memory 119 used to call native operator procedures in sequence to form the code stream 120 for execution in execution unit(s) 115b.

It is noted that, although computing systems 104a-b are referred to herein as separate computing systems, these computing systems could in fact be stand-alone systems or partitions of a larger computing system, with the processing and memory resources of those systems corresponding to the sub-portions of the system allocated to that partition.

Referring now to FIG. 2, an example computing system 200 is disclosed which can be configured to execute a translated code stream based on a non-native code stream, for example emulated code as processed by interpreter software. The computing system 200 can in some embodiment represent computing system 104b, reflecting the fact that at one time the non-native code stream received at the computing system 200 was written for an instruction set architecture supported by a different hardware system.

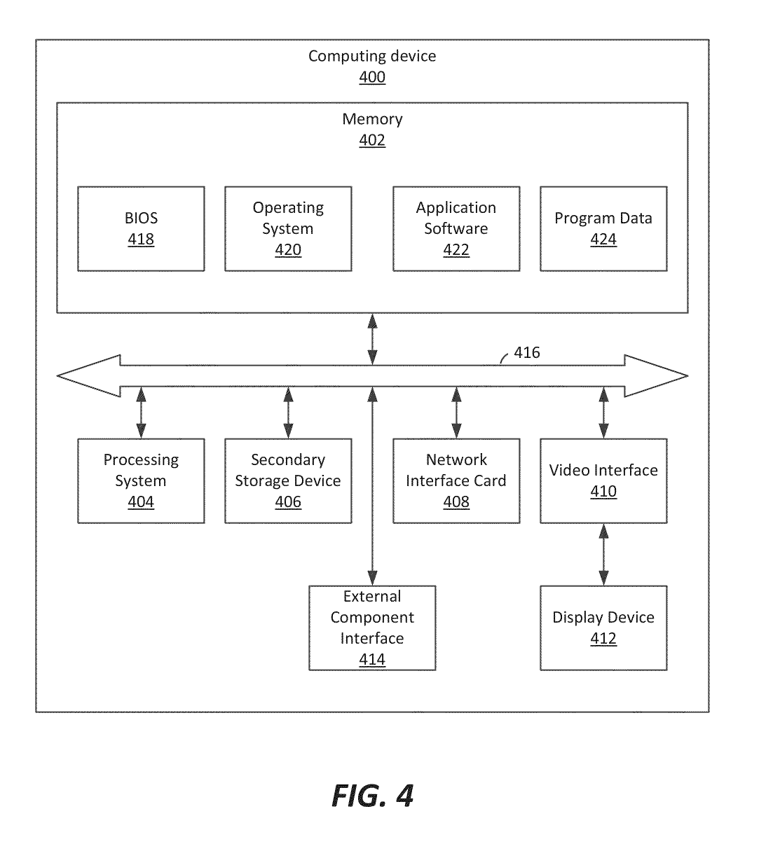

The computing system 200 is configured to receive a non-native code stream 102 in memory, and execute that code stream using an interpreter component, shown as an adaptive interpreter 202. In the embodiment shown, the adaptive interpreter 202 is configured to generate a shadow memory 204 that includes parsed and translated native code sequences, and also can generate, as a second process, code stream 120 from the shadow memory 204. As discussed in further detail below, the shadow memory 204 can include one or more shadow code arrays from which the code stream 120 can be formed for execution on native hardware (e.g., as shown in FIG. 4, discussed below).

As discussed above, the code stream 102 is a non-native code stream, meaning that it is written for execution on an instruction set architecture that is incompatible with the instruction set architecture of the computing system 200. In some embodiments of the present disclosure, the computing system 200 operates using an Intel-based (x86-based) instruction set architecture (e.g., IA32/x86, IA32-x64/x86-64, IA64, etc.), while the code stream 102 can be written for any of a number of other types of instruction set architectures, such as PowerPC, ARM, MIPS, SPARC, or other similarly incompatible system architectures.

In general, in the context of the present disclosure, the adaptive interpreter 202 is configured to generate a translated code stream 120 of native instructions that can be executed natively on an instruction set architecture of the computing system 200. The translated code stream 120 can in turn be executed by native hardware, such as processing unit 110b. An example architecture in which various processing modules manage execution of translated code streams is discussed in further detail below in connection with FIG. 3.

In some embodiments, the adaptive interpreter 202 can include an environment that hosts a parsing component configured to interpret code stream 102, as well as an execution component configured to manage generation of code stream 120 from the shadow memory 204. For example, the adaptive interpreter 202 could include memory configured to emulate an architecture of a non-native system, and can, when translated code stream 120 is executed, call a variety of routines to change an emulated system state.

In some embodiments, the adaptive interpreter 202 corresponds to an emulated computing system module, and translation and execution correspond to coordinated execution of a parser relative to the code stream 102 and used to establish shadow code arrays in shadow memory 204, and an execution component used to manage generation and execution of the translated code stream 120. In other embodiments, one or more different modules could be used to execute the functions of the adaptive interpreter 202. Generally, the adaptive interpreter 202 can be configured to detect whether one or more sentences exist within the code stream 102 (i.e., the code actually executed). In the context of the present disclosure, a sentence corresponds to a complete logical thought, such as a combination of a load operation to retrieve one or more data values, a performance of one or more operations on those data values, and a store operation that returns the newly-calculated values to memory. In such cases, and as discussed below, specific parser types may be selected which can detect sentences that fit within a native computing system's available processing resources (e.g., registers, cache, etc.) to provide some type of optimized execution of those sentences by the native computing system 200. This may be, for example, executing one or more non-native, stack-based operations within registers of a native, register-based computing system, or otherwise minimizing memory access or other utilization of (comparatively) slow computing subsystems.

Now referring to FIG. 3, a block diagram of an example embodiment of an adaptive threaded virtual processing system 300 is shown, according to a possible embodiment of the present disclosure. The adaptive threaded virtual processing system 300 includes a plurality of adaptive virtual processors, which can in some embodiments be implemented using an adaptive interpreter 202. In the embodiment shown, adaptive interpreters 202a-b are shown; in alternative embodiments other numbers of such interpreters 202 could be used as shown. In such embodiments, each adaptive interpreter 202 can be associated with or assigned to a different physical or logical processing core of a native computing system, as illustrated in FIG. 1, above.

In the embodiment shown, each of the adaptive interpreters 202 are interfaced to a system memory 302 via a system bus 304. The system memory 302 stores the non-native code, shown as E-mode code 306, for parsing by the adaptive interpreters 202 and execution via those interpreters and the underlying native processing cores. It is noted that, in the context of the present disclosure, the E-mode code 306 corresponds to a proprietary language compatible with the Unisys Clearpath/MCP computing system. The E-mode code 306 is therefore written to be compliant with a stack-based computing system architecture, and includes instructions that are defined in terms of operation by both an operator (which defines a task to be performed by that instruction) and operands on which the operator may act. In particular, different data types for different operands may cause the operator to perform differently. For example, a floating point multiply operation may be performed differently in hardware than an integer multiply operation, which may be performed differently if a double-precision or single-precision number, or even a string value. Other examples exist as well. It is noted that a tag associated with one or more operands can define the data type of that operand, and therefore to fully define a particular instruction, an operator and associated operands (including operand tags) should be inspected.

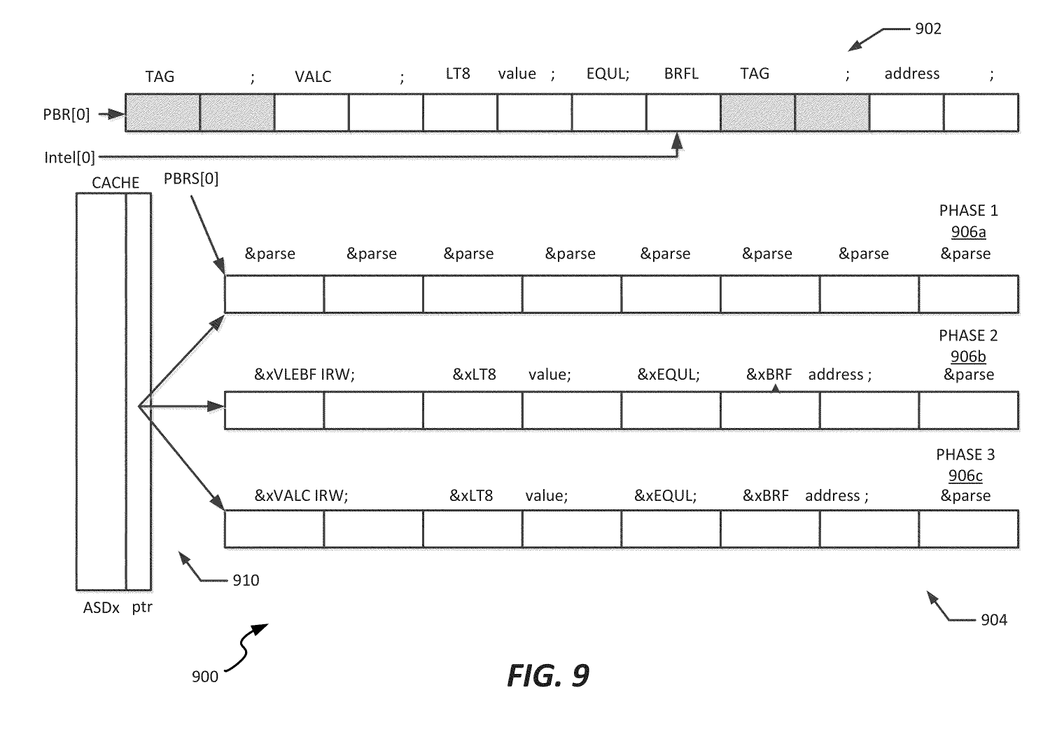

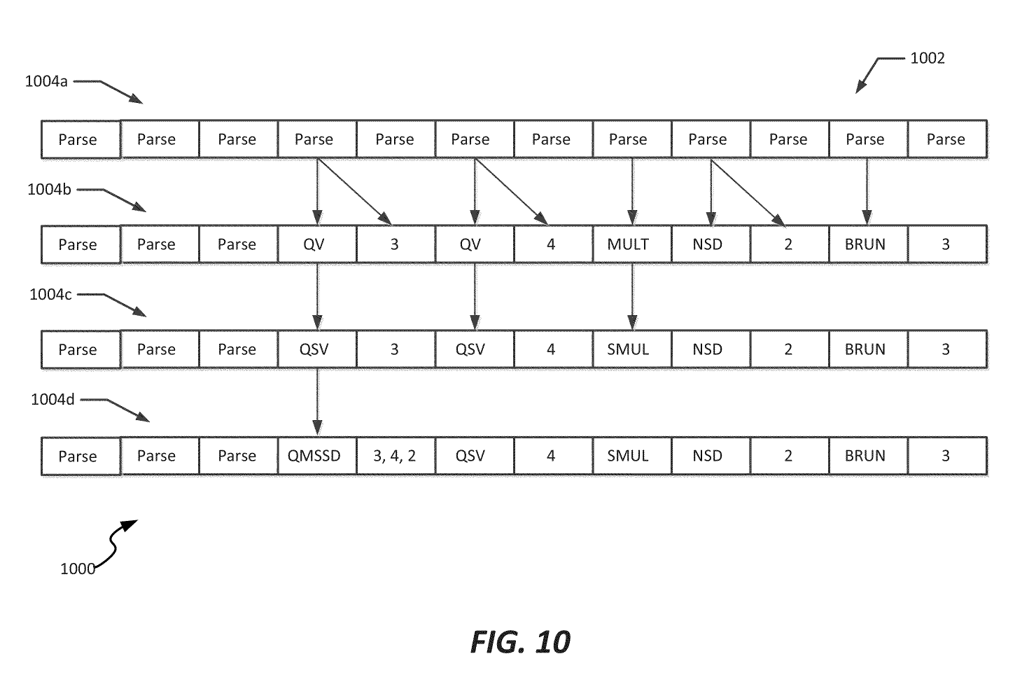

In the embodiment shown, the system memory 302a also stores shadow memory, which includes shadow code arrays 308. The shadow code arrays can be created on a per-program and per-processor (e.g., per-interpreter) basis. In this way, each shadow code array is constructed such that it is likely that the native instructions to be included in that shadow code array (as illustrated in the examples of FIGS. 9-10, below) are consistently performed with respect to the same workloads, and therefore that changes in data types of operands included in those instructions do not change. This is because typically similar workloads will be assigned to the same logical processor by the native operating system of a computing system that hosts the adaptive threaded virtual processing system 300 discussed herein.

In example embodiments, the shadow code arrays 308 can be allocated by an adaptive interpreter at the time E-mode code 306 is selected for execution; as further discussed below, the shadow code arrays 308 have a size corresponding to that of the E-mode code 306, with each byte of E-mode code corresponding to a 64-bit word of the shadow code array. The shadow code array word entries can be used, for example, to store pointers to procedures (e.g., procedures 310) that implement native versions of the non-native operators.

In the embodiment shown, the system memory 302 includes a set of stored procedures 310. The stored procedures correspond to addressable locations at which callable locations are maintained. Each of the stored procedures in the set of stored procedures 310 performs a task equivalent to the processes performed by one or more non-native instructions, and can be referenced in shadow code arrays 308. In this way, the shadow code arrays 308 can be allocated using constant-sized memory spaces based on the size of the non-native code, and can use pointers to a stored procedure in the set of stored procedures 310 to correspond to native instructions. It is noted that this is made somewhat more straightforward by the fact that E-mode code 306 has separately stored instructions and data, and therefore instruction memory can readily be “shadowed” with minimal worry regarding the effect of changes to data.

In some embodiments, the system 300 represents a particular example embodiment in which a Unisys Clearpath/MCP computing system is emulated on a computing system having a different instruction set architecture, for example using an Intel-based instruction set architecture. In the context of the present disclosure, a code stream written for execution on a Unisys Clearpath MCP system software can be translated for execution using native instructions of the Intel-based instruction set architecture. In the MCP environment, the non-native instructions, or foreign operators, comprise the proprietary E-Mode code 306. The native instructions, stored in shadow code arrays 308, in some embodiments refers to the Intel 64 and Intel architecture (IA) 32 instruction sets; however, in alternative embodiments configured for execution on different hardware, other systems architectures could be used as well.

In use, the adaptive interpreters 202 generally perform a two-step process for executing non-native instructions; each adaptive interpreter 202 includes a parsing component 312 which is configured to parse the E-mode code 306, translate that code, and store the translated code in shadow code arrays 308. Each adaptive interpreter also includes an execution component 314 configured to execute the translated, native code from the shadow code arrays 308. In some embodiments, only one parsing component is included in an overall system 300, while multiple execution components are included, on a per-processor basis.

The parsing component 312 can be, for example part of an overall adaptive interpreter, or can be a separate and independent component. In example embodiments, and as further discussed below, the parsing component 312 can include a look-ahead left-to-right (LALR) parser that is configured to parse the E-mode code 306 to be executed for determining native operators, as well as for determining a set of instructions that can be reliably performed using register-to-register operations and avoiding memory accesses (that would otherwise represent stack access/modification in the non-native architecture).

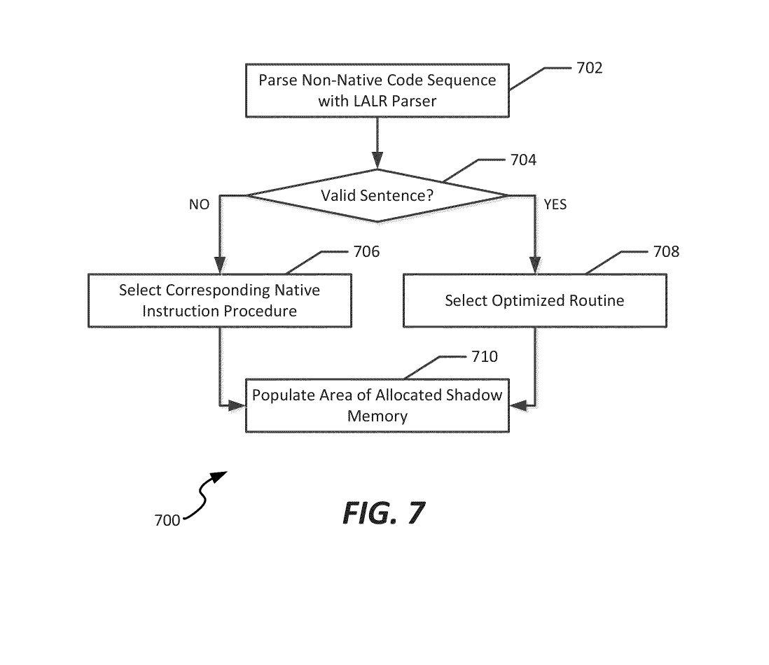

In some embodiments, native code can be generated based on analysis of the E-mode code 306 by a parser that is configured to detect areas where efficient translations could take place. This could be, for example, a place where stack touches are minimized, or otherwise where memory accesses or other time-intensive operations can be avoided. For example, the parsing component 312, such as an LALR parser, can be used to parse the E-mode code 306 to determine where optimized native procedures may exist. As illustrated in further detail below in connection with FIG. 7, as the parsing component 312 assesses fragments of the E-mode code 306, it will either return an indication that a code sentence end has been reached, or that an error has occurred (i.e., no sentence end has been reached before some exception condition.

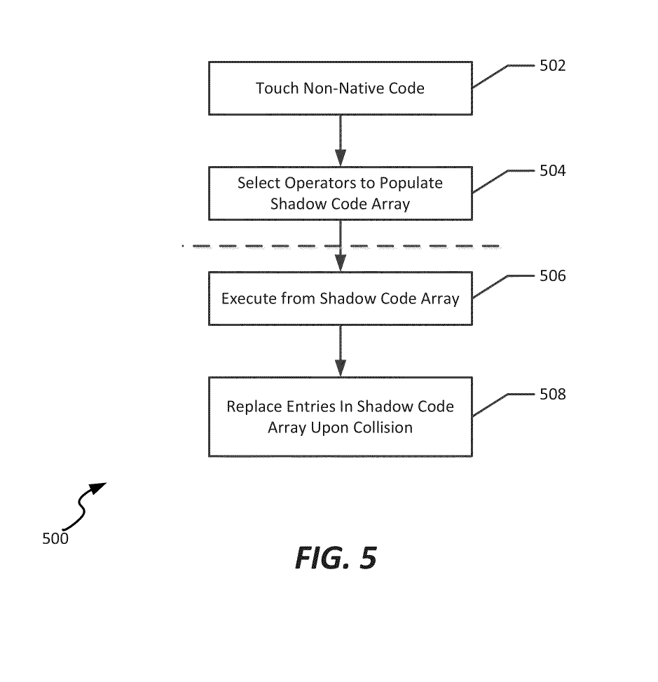

Additionally, various portions of the shadow code arrays 308 can be cached in a cache 316, and are managed on a per-processor basis (shown as a per-interpreter 202 basis); additionally, the caching is on a per-processor (logical or physical) basis. Accordingly, each processor can independently cache shadow code, and caches are replaced on a per processor basis. As such each processor could independently parse the E-mode code via a separate parsing component 312, or can independently cache code that is parsed on behalf of the overall system in an initial stage of the adaptive interpreter 202. Additional details regarding example embodiments of the adaptive interpreters 202 are described below in connection with FIGS. 5-10.

Referring now to FIG. 4, a schematic illustration of an example computing system in which aspects of the present disclosure can be implemented. The computing system 400 can represent, for example, a native computing system within which one or more of systems 104a-b, 200, or 300 could be implemented. In particular, in various embodiments, the computing device 400 implements one particular instruction set architecture, and can be used to execute non-native software and/or translate non-native code streams in an adaptive manner, for execution in accordance with the methods and systems described herein.

In the example of FIG. 4, the computing device 400 includes a memory 402, a processing system 404, a secondary storage device 406, a network interface card 408, a video interface 410, a display unit 412, an external component interface 414, and a communication medium 416. The memory 402 includes one or more computer storage media capable of storing data and/or instructions. In different embodiments, the memory 402 is implemented in different ways. For example, the memory 402 can be implemented using various types of computer storage media.

The processing system 404 includes one or more processing units. A processing unit is a physical device or article of manufacture comprising one or more integrated circuits that selectively execute software instructions. In various embodiments, the processing system 404 is implemented in various ways. For example, the processing system 404 can be implemented as one or more physical or logical processing cores. In another example, the processing system 404 can include one or more separate microprocessors. In yet another example embodiment, the processing system 404 can include an application-specific integrated circuit (ASIC) that provides specific functionality. In yet another example, the processing system 404 provides specific functionality by using an ASIC and by executing computer-executable instructions.

The secondary storage device 406 includes one or more computer storage media. The secondary storage device 406 stores data and software instructions not directly accessible by the processing system 404. In other words, the processing system 404 performs an I/O operation to retrieve data and/or software instructions from the secondary storage device 406. In various embodiments, the secondary storage device 406 includes various types of computer storage media. For example, the secondary storage device 406 can include one or more magnetic disks, magnetic tape drives, optical discs, solid state memory devices, and/or other types of computer storage media.

The network interface card 408 enables the computing device 400 to send data to and receive data from a communication network. In different embodiments, the network interface card 408 is implemented in different ways. For example, the network interface card 408 can be implemented as an Ethernet interface, a token-ring network interface, a fiber optic network interface, a wireless network interface (e.g., WiFi, WiMax, etc.), or another type of network interface.

The video interface 410 enables the computing device 400 to output video information to the display unit 412. The display unit 412 can be various types of devices for displaying video information, such as an LCD display panel, a plasma screen display panel, a touch-sensitive display panel, an LED screen, a cathode-ray tube display, or a projector. The video interface 410 can communicate with the display unit 412 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 414 enables the computing device 400 to communicate with external devices. For example, the external component interface 414 can be a USB interface, a FireWire interface, a serial port interface, a parallel port interface, a PS/2 interface, and/or another type of interface that enables the computing device 400 to communicate with external devices. In various embodiments, the external component interface 414 enables the computing device 400 to communicate with various external components, such as external storage devices, input devices, speakers, modems, media player docks, other computing devices, scanners, digital cameras, and fingerprint readers.

The communications medium 416 facilitates communication among the hardware components of the computing device 400. In the example of FIG. 4, the communications medium 416 facilitates communication among the memory 402, the processing system 404, the secondary storage device 406, the network interface card 408, the video interface 410, and the external component interface 414. The communications medium 416 can be implemented in various ways. For example, the communications medium 416 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 402 stores various types of data and/or software instructions. For instance, in the example of FIG. 4, the memory 402 stores a Basic Input/Output System (BIOS) 418 and an operating system 420. The BIOS 418 includes a set of computer-executable instructions that, when executed by the processing system 404, cause the computing device 400 to boot up. The operating system 420 includes a set of computer-executable instructions that, when executed by the processing system 404, cause the computing device 400 to provide an operating system that coordinates the activities and sharing of resources of the computing device 400. Furthermore, the memory 402 stores application software 422. The application software 422 includes computer-executable instructions, that when executed by the processing system 404, cause the computing device 400 to provide one or more applications. The memory 402 also stores program data 424. The program data 424 is data used by programs that execute on the computing device 400.

Although particular features are discussed herein as included within an electronic computing device 400, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Referring now to FIG. 5, a flowchart illustrating methods and systems for generating and executing a translated code stream corresponding to a translation of a plurality of non-native operators is shown, according to an example embodiment. The methods and systems illustrated herein, shown as process 500, can be performed by or implemented in an adaptive interpreter, such as adaptive interpreters 202 described above.

In the embodiment shown, a non-native code execution operation 502 reaches a code sequence in non-native code, such as E-mode code. The non-native code execution operation 502 detects that the code sequence is touched and that there is no corresponding shadow array that has previously been generated. This can include advancing an instruction pointer through both native and non-native code, to a code sequence that requires parsing/translation. The non-native code execution operation 502 can, in some embodiments, correspond to reaching a “parse” operation stored in a shadow code array that indicates to the adaptive interpreter that a corresponding native operator or operators have not been generated that correspond to the non-native operator. In such a case, the “parse” operation in the shadow code array would indicate to the adaptive interpreter to interpret the code sequence at the corresponding instruction pointer in the non-native code.

An operator selection operation 504 corresponds to selection of one or more operators that perform an analogous task to that indicated in the non-native operator included in the non-native code at the instruction pointer. In some embodiments, the operator selection operation 504 parses each of the non-native operators in a code sequence, to determine the tasks performed by that code sequence and determine a set of one or more corresponding native operators that perform an analogous task. In some embodiments, this can be accomplished on an operator-by-operator basis within a code sequence; in other embodiments, the collective tasks performed by multiple operators are analyzed and one or more corresponding native operators are selected to perform analogous tasks. For example, two or more non-native operators could be concatenated and the collective task associated with those operators could be performed by one or more native operators.

In some embodiments, the non-native code execution operation 502 and the operator selection operation 504 are implemented in a look-ahead left-to-right (LALR) parser that is configured to parse a code sequence for determining native operators, as well as for determining a set of instructions that can be reliably performed using register-to-register operations and avoiding memory accesses. Since register-based architectures are typically memory bound (e.g., an Intel-based architecture may have substantial execution parallelism but is bound by a single memory read and write at a time), it is a particular goal of the present disclosure to minimize memory accesses, which would otherwise be a typical way to emulate stack operations of a non-native (e.g., Unisys Clearpath/MCP) system. Of course, in alternative embodiments, other types of parser formats could be used, with the same goal of minimizing memory operations while maintaining an accurate stack state.

Traditionally, an LALR parser can be used to determine if a file represents a syntactically valid computer language, such as COBOL or C++. In embodiments of the present disclosure where an LALR parser is used, and in particular when used in connection with a non-native architecture that is stack-based, that parser can be used to analyze syntax and semantics of a non-native code sequence (e.g., E-mode code) to determine the presence (or absence) of a sentence within a particular set of instructions of a predetermined length. This can be used, for example to identify whether a sequence of code can safely be emulated without changes occurring to a stack state of a stack-based architecture. Sequences generally end in an LALR error when the end of a “safe” sequence (a sequence in which stack state does not change) is found—that is, an error occurs when a condition is detected that renders a particular code sequence unsafe for use without updating a stack state. This can be used to determine the extent to which registers in a register-based native instruction set architecture can be utilized in native operations that would otherwise correspond to the non-native operators. An error recovery process of the LALR parser could then perform the operator selection operation 504 to select a transformation of the “safe” string in the first level of the interpreter. In other words, the LALR parser looks for areas where a result of a series of non-native instructions, such as in the E-mode code, is self-contained, or where the number of references to the top of stack is minimized. To the extent that stack access occurs, it may then be possible to model stack operations in registers, rather than solely in memory. One example of such an arrangement is illustrated in further detail below in connection with FIG. 7.

It is noted that a typical location at which stack push/pop occurrences would happen is at a branch or string instruction (i.e., entry/exit from a non-native procedure); accordingly, and as discussed in further detail herein, the string of operators is referred to as a code segment. Accordingly, sequences of instructions that are considered “sentences” by an LALR parser generally do not span across multiple code segments, which are typically be terminated by a conditional branch or string operation or some other stack-affecting operation as detected by the LALR parser. Code sequences, which may or may not be sentences, are generally sub-portions of such code segments.

Referring still to FIG. 5, and based on operations 502, 504, the selected native operators are stored in shadow memory, in a shadow code array (e.g., shadow code array 308) that represents the string of instructions in a particular code sequence or sequences, in order, to be executed. An execution operation 506 executes code streams from such shadow code arrays in shadow memory. The execution operation 506 generally executes the set of native operators from shadow memory.

Adaptive operation 508 is performed to adjust the contents of a shadow code array to accommodate changes to the native operators included in that shadow code array based on changes to the data on which the non-native code stream operates on. By way of example, this may occur based on changes to the data type of operands that are acted upon by the operators defined in the non-native instructions. This may be the case when the non-native instructions are defined to execute on a number of types of operands, whereas the native instructions include optimized instruction types that operate on operands of particular types. For example, in cases where the non-native instructions are compatible with a Unisys Clearpath/MCP computing system and the native instructions are compatible with an x86 processing architecture (e.g., IA 32, etc.), a non-native instruction (e.g., “move”, “add”, etc.) may be represented by many different native instructions, depending upon the data on which the instruction operates. This may also be the case where at least a portion of the task performed by an operator is dictated by the data type of the operands on which the operator acts. For example, a particular mathematical operator may perform a task differently (and with differing levels of efficiency) based on whether operators having integer, floating point, or other data types are acted upon. Example data types that may affect the type of native operator that is selected for execution can include, for example, whether the operand is an integer (signed or unsigned), a floating point number, a Boolean, a string, or a double precision integer or floating point operand. Other types of operands could affect the selection of native operators as well.

Referring still to adaptive operation 508, it is noted that, even though each processor core is assigned its own executing thread in which the adaptive interpreter can be run, those processor cores may still be provided with instructions for which the data types have changed. In connection with the present disclosure, the adaptive operation 508 allows for correction of a translation, such that an initial translation of a non-native instruction in the operator selection operation 504 can be adjusted if a data type of an operand changes between execution occurrences. In this way, the operator selection operation 504 can aggressively select the most efficient of native operators that corresponds to the non-native operator(s), without regard to possible future changes of data type of operands. Subsequent changes to data type of the operands can result in the adaptive operation 508 selecting a more general-purpose native instruction or otherwise selecting an instruction for execution that ensures that the new data type of supported. As noted above, examples of this adaptive operation 508 are provided below, in connection with FIGS. 9-10.

It is noted that, in various embodiments, multiple instances of the process 500 can be implemented in a particular computing system, for example one per execution core, as mentioned above in connection with FIG. 3. Accordingly, multiple versions of non-native code execution operation 502, operator selection operation 504, execution operations 506, and/or adaptive operation 508 could be utilized. In some embodiments, a complete system 500 is implemented with respect to each separate processor core of a computing system; in alternative embodiments, only a portion of the system is replicated per core (e.g., each core having its own shadow code arrays and independently executing execution operation 506 and adaptive operation 508). Other embodiments are possible as well.

It is noted that, in the context of the present disclosure, the methods and systems described herein can also be configured to be executed such that operations occur concurrently; for example, the non-native code execution operation 502 and the operator selection operation 504 may occur sequentially, or in conjunction, and in parallel with the execution operation 506 and adaptive operation 508. This may be the case, for example, where operand mismatch is detected based on the contents of the non-native memory, rather than based on the operands included in the shadow code array.

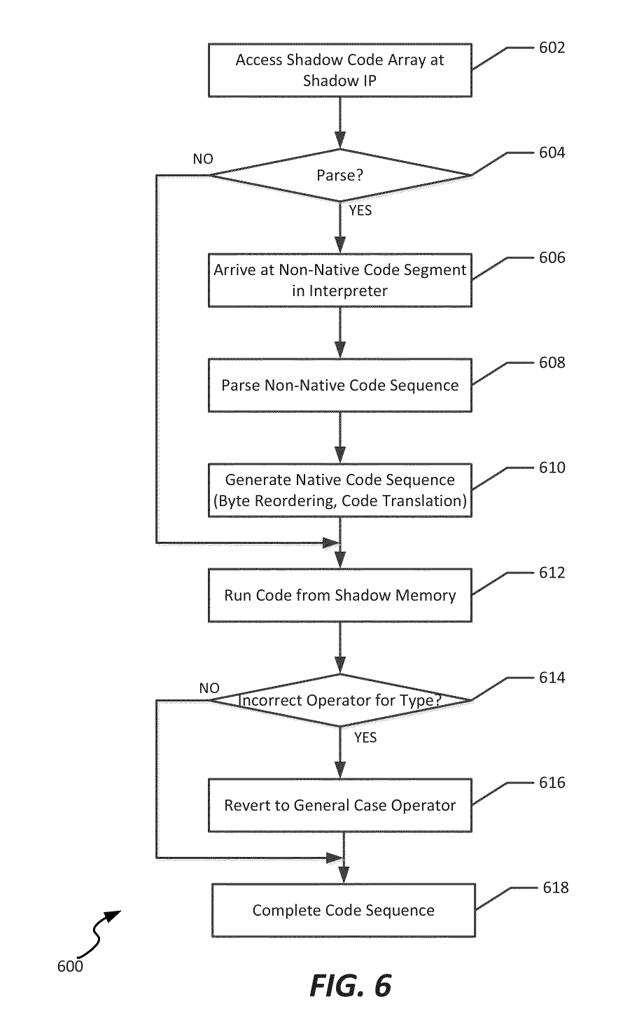

Referring now to FIG. 6, a flowchart of methods and systems for adaptively generating native code in a shadow code array for execution are shown, according to an example embodiment. The methods and systems of FIG. 6, represented generally as process 600, can be implemented as a particular embodiment of the methods and systems of FIG. 5, as applied to a particular code sequence of non-native code.

At operation 602, a shadow code array is accessed to determine native instructions (if present) to be executed that corresponds to a non-native code sequence. If the shadow code array is accessed for the first time, rather than having instructions, a “parse” operation or other type of placeholder will be stored in the shadow code array, and will indicate to the adaptive interpreter that parsing of the non-native code is required. Accordingly, from operation 604, the adaptive interpreter proceeds to operation 606, in which the adaptive interpreter arrives at a non-native code sequence. The non-native code sequence can correspond to a set of contiguous or non-conditional instructions that are executed in-order during execution of code. This can correspond to arrival at the non-native code sequence by way of a virtualized non-native instruction pointer maintained by an adaptive interpreter, which is synchronized to a native instruction pointer that references the shadow code arrays containing the corresponding native instructions. Operation 608 includes parsing the non-native code sequence encountered at operation 606.

Native code sequences are generated at operation 610 based on the parsed non-native code sequence. This process can include a variety of types of translation processes, including parsing of instructions, byte reordering, and task translation. For example, in the case of E-mode instructions being translated to x86 or other Intel-based instructions, a sub-process included in operation 610 can perform byte reordering (from big-endian to little-endian) and byte translation from 6-bit to 8-bit words for translation between operators of the non-native and the native language. This can occur, for example, using the LALR parser as discussed above in connection with FIG. 5. Furthermore, in example embodiments, the translation of E-mode instructions can be performed with knowledge of a current stack state at the time the instructions are reached; accordingly, this provides insight into the likely data types of operands on which the instructions are to be executed, and therefore informs the LALR parser (and operation 610) as to which of a number of available native operator procedures should be used, where multiple such procedures are available for execution on different data types. A pointer to the corresponding native code is then stored in the shadow code array, in place of the “parse” operation. Example aspects of this parsing and translation process are described in further detail below in connection with FIG. 7.

Once operation 610 has been completed (i.e., a first pass through the non-native code has been completed for a particular shadow code array and associated adaptive interpreter), operation 612 executes the native code from the shadow code array. This can occur either immediately following population of the shadow code array in operation 610, or during a subsequent execution of the code sequence (i.e., in which case the shadow code array is already populated and therefore operation 612 is reached from operation 604.

At operation 614, the adaptive interpreter can determine whether the native operator is mismatched with one or more operands on which that native operator is intended to act. If there is no mismatch, operational flow branches “no”, and execution proceeds normally, with execution of the code sequence completed at operation 618. However, if there is a mismatch between a native operator and a data type of an operand, an adaptive operation 616 causes reversion of the operator in the shadow code array to a different type of operator. In some embodiments, the different operator could be selected to only operate on the updated data type; however, in other embodiments, the different operator can be, for example, a more general purpose version of the same operator that can operate on operands of differing data types. Following adaptive updating of the operand, operation 618 causes completion of execution of the code sequence, thereby allowing the adaptive interpreter to move to the next sequential code sequence.

FIG. 7 is a flowchart of methods and systems for determining native code to be executed based on a non-native code sequence are shown. The methods and systems illustrated herein, shown as process 700, can be performed by or implemented in an adaptive interpreter, such as adaptive interpreters 202 described above, and form a portion of the overall execution flow of a process 600 above, i.e., as illustrated in operations 608-610, above.

In the embodiment shown, at operation 702, the non-native code sequence that is accessed (e.g., via operation 608 of FIG. 6) is parsed and translated from the non-native format to the native format (e.g., in terms of byte length/ordering/signing). The sequence of non-native code is then assessed, for example by the LALR parser, to determine whether a valid sentence exists at the location of non-native code. In other words, the parser will determine if there is a complete thought reflected in the non-native code that can be represented as an optimized, native representation of the same code sequence (i.e., can perform the same task). If no such sentence exists, operation 706 simply selects a corresponding procedure, written in native code and accessible to the parser, for use as a corresponding task for each non-native instruction of the sequence. If a sentence does exist, at operation 708 a corresponding optimized routine is selected, which can include a particular sequence of instructions that minimizes memory accesses (e.g., simulated stack touches). The selected routine, from operation 706 or operation 708, is then stored in the shadow code array at the corresponding “parse” operation, and subsequently executed as described above and illustrated in FIG. 6.

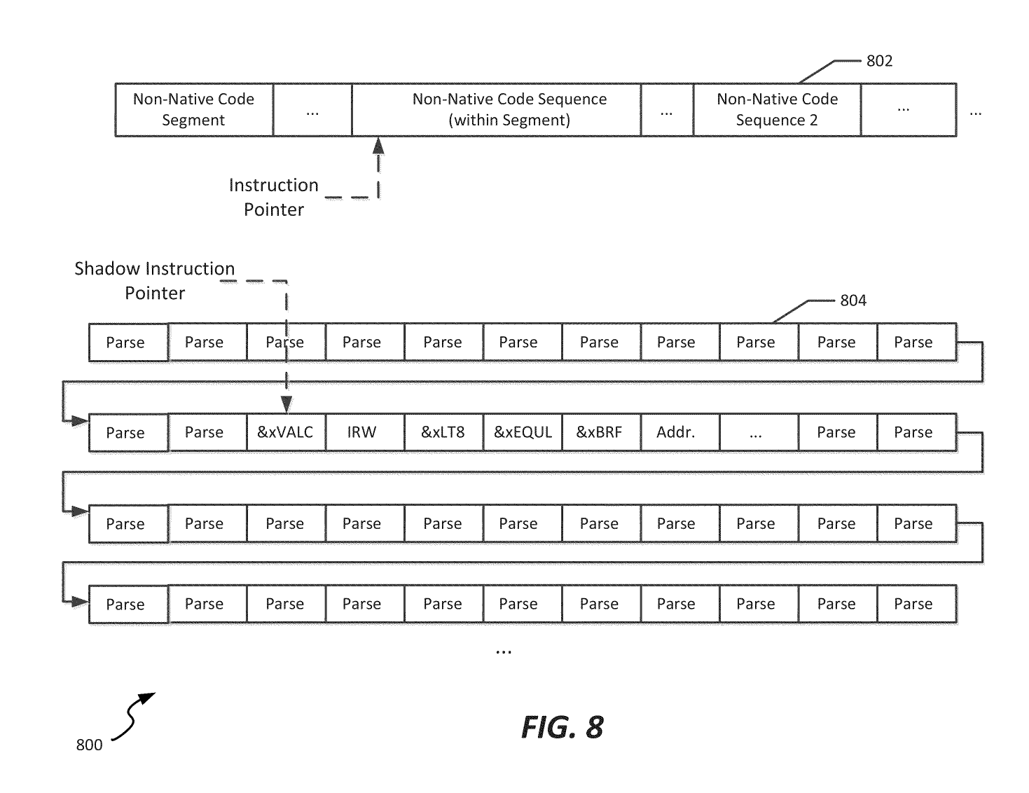

It is noted that, in connection with FIGS. 5-7, only those sections of non-native code will ultimately be translated such that a corresponding pointer to a native procedure will populate the shadow code array. Otherwise, the “parse” operations will be maintained as placeholders for those sections that are not reached by the processor associated with that shadow code array. This arrangement is illustrated in FIG. 8, which provides a schematic illustration of memory 800 that includes non-native code 802 and native code 804. As shown, execution occurs from a shadow instruction pointer into the shadow code array, which is sized according to the length of the non-native code 802. Generally, the shadow instruction pointer will proceed through the shadow code array 804 without regard to the non-native code 802 unless a “Parse” instruction is encountered, at which time the instruction pointer to the non-native code 802 is updated and the parsing procedure described above in FIGS. 6-7 is performed.

It is noted that, in connection with the present disclosure, the shadow code array value may vary, for example based on subsequent execution of the same area of the shadow code array at different times, and based on differing conditions (e.g., different operands on which the shadow code array is to be executed). Referring now to FIGS. 9-10, examples of the systems and methods discussed above are provided, to illustrate the adaptive nature of the use of shadow code arrays and associated native operator translation. Referring first to FIG. 9, a logical diagram of an adaptive translation scheme 900 is shown, in which non-native code 902 is adaptively translated for storage in a shadow code array, according to an example embodiment. The logical diagram of FIG. 9 represents an adaptation occurring within a system executing non-native code corresponding to that shown in FIG. 8, while the diagram of FIG. 10 illustrates a further possible example of such adaptation.

In the adaptive translation scheme 900 illustrated in FIG. 9, a non-native code stream, shown as non-native code 902, is designed to perform a VALC, LT*, EQUL, BRFL set of E-mode instructions as part of a code stream. This involves, in the embodiment shown, 8 bytes of E-mode code, and 3 push, 3 pop, and 3 E-mode code reads (E-mode code being written for an MCP, stack-based architecture). As specifically illustrated, the non-native code has an associated initial index location, shown as PBR[0] and representing a start of a code sequence, and a secondary pointer, shown as Intel[0], at the end of that code sequence. A corresponding shadow pointer, PBRS[0], points to a corresponding initial location in a shadow code array that corresponds to the non-native code sequence. As seen in the example non-native code 902, the initial index location points to a tag representing the entry point to the code segment. As noted above, the code segment is terminated at the BRFL, a branch instruction that is included in the E-mode code definition and from which flow control may vary based on the result of prior operations (e.g., in this case at the end of a code segment).

In the embodiment shown, three phases of a shadow code array 904 are shown, each of which represents a different modification of the shadow code array based on a time at which the non-native code 902 is encountered. In a first phase, shown as phase 906a, the shadow code array 904 is fully populated with “parse” placeholders, indicating that the non-native code needs to be parsed to locate the associated native instructions. In the context of this embodiment, the “parse” placeholders correspond to a function that uses the non-native instruction pointer to locate a byte of code and discover the operator to be executed. The result of a “parse” operation is that a procedure name (C++ pointer) is placed in the shadow code array at a corresponding location, and having the same corresponding length in terms of number of elements as are present in the E-mode code. It is noted that the shadow code array 904 in the embodiment shown includes sequential 64-bit words in native byte-order, and without tags, such that pointers to a cache 910 that stores native (e.g., Intel) instructions used to perform the same task as is defined in the code sequence of non-native code 902. Accordingly, the shadow pointer PBRS[0] advances by 64-bit word size increments, rather than increments defined by the non-native architecture.

In a second phase 906b, each of the non-native instructions is now translated to native instructions, with VALC being translated such that the shadow code array 904 includes a pointer to an xVLEBF instruction, the LT8 being translated to an xLT8 instruction (with the pointer to that instruction stored in the shadow code array 904), the EQUL instruction similarly associated with xEQUL, and BRFL associated with xBRF. It is noted that each pointer references a routine in a cache 910 that contains a pointer that can be used to populate shadow memory, as well as a set of native instructions used to perform the corresponding operation. As noted above, the shadow code array 904 includes an element for each byte of the non-native code. Accordingly, if the byte is the first byte of a non-native opcode, then the corresponding element of the shadow array is a procedure name.

It is noted that, in the example illustrated in FIG. 9, the VALC instruction is parsed, and the adaptive parser has a number of options regarding native code to which it can be translated. It is noted that, based on prior experience, the operands associated with the VALC instruction are most likely unsigned integers; as such, the interpretation of the VALC instruction is to use the xVLEBF instruction routine, which executes on unsigned integers. Accordingly, in this implementation, rather than requiring use of a general purpose version of a VALC-equivalent native instruction, the xVLEBF instruction is directly stored in the shadow code array 904.

In a third phase 906c of operation, it is later determined (for example, either during the same execution sequence or at a later time) that one or more operands associated with an operator stored in the shadow code array do not match the native operator selected. As illustrated in the third phase 906c, the xVLEBF instruction is replaced with a more generic instruction, xVALC, which can be performed on unsigned integers, but could also be performed on other data types (e.g., floating point types). The determination that such a mis-match occurs could be performed within the procedure stored in the shadow code array itself; in other words, in this example, the xVLEBF will include a self-check process in which it determines that the operands on which it is about to execute are not both unsigned integers. Upon detecting such an arrangement, a fallback procedure (in this case, xVALC) could be defined to replace the existing instruction, or could be defined as requiring the corresponding non-native code 902 to be re-parsed based on current values to determine whether, based on the current operands, one or more different optimizations could be made. Accordingly, since after the second phase 906b it was determined that operator xVLEBF did not match a corresponding operand, that operand was replaced for subsequent execution of the native code from the shadow code array 904.

In this way, operators can be initially selected that are the most efficient in executing a particular non-native instruction based on past experience with that instruction (or instruction sequence), while being adaptive to subsequent changes in data types. Furthermore, since the shadow code array 904 is generated on a per-logical processor basis, the shadow code array is more likely to be maintained in its current state, rather than being affected by workloads that may execute from the same shared code but do so based on other precursory data operations that may change the data types of operands.

FIG. 10 illustrates a further example of adaptive translation of a non-native code sequence to native code using an adaptive interpreter as discussed herein. In the embodiment shown, an adaptive translation scheme 1000 is illustrated. For brevity, the non-native code and associated cache are not illustrated in FIG. 10; however, those elements are analogous to those provided in FIG. 9, above. Rather, for purposes of simplicity, below the example illustration provided is performed based on the following code sequence:

CODE SEGMENT # 2 (0002) : MAIN

| | | |
|---|---|---|
| 002:0000:0 NVLD | FF | (segment:word:byte) |
| 002:0000:1 NVLD | FF | |
| 002:0000:2 NVLD | FF | |

100 a = b * c

| | |
|---|---|
| 002:0000:3 VALC (03,0003) 3003 | (00000200 IN MAIN) |

002:0000:5 VALC (03,0004) 3004

| | |
|---|---|
| 002:0001:1 MULT | 82 |

002:0001:2 NAMC (03,0002) 7002

| | |
|---|---|
| 002:0001:4 STOD | B8 |

goto 100

| 002:0001:5 BRUN 0000:3 | A26000 | |
|---|---|---|
| 002:0002:2 EXIT | A3 | (00000300 IN MAIN) |

[tag]FFFFFF300330 [tag]04827002B8A2 [tag]6000A3B0B0B0
EMODE CODE :FF FF FF 3003 3004 82 7002 B8 A2600

| | |
|---|---|
| 3 nvld | VALC VALC MULT NAMC STOD BRUN |

In this embodiment, a first phase 1004a of shadow code array 1002 will be fully populated by “parse” operations, indicating that the shadow code array has been allocated for use in connection with a particular non-native code sequence, but that the code sequence has not yet been parsed and translated. A second phase 1004b illustrates an initial translation in which a code sequence is stored in the shadow code array 1002 for a code sequence starting at 2:0:3, with variables a, b, and c corresponding to single precision variables.

In the embodiment shown, each element in the shadow code array corresponds to a byte of the non-native code to which it corresponds. Furthermore, as noted in FIG. 9, each corresponding element in the shadow code array 1002 is a pointer to a procedure that performs the non-native instruction, and is written in native instructions.

As seen in further detail in the subsequent phases 1004b-d of FIG. 10, and as briefly discussed in connection with the example of FIG. 9, each time code is executed from the shadow array, it can become more (or less) optimized, depending upon the differences in operation encountered. In a second phase 1004b, the parse operations are replaced by initial sets of instructions QV, QV, MULT, NSD and BRUN, with associated values. In third phase 1004c, the initial QV elements are replaced by QSV instructions, and MULT is replaced by a SMUL operation. In the context of the present disclosure, QV and QSV are optimized versions of the VALC operation, where QV is used if the operand is a local value, and QSV is used if that operand is a single operand. Similarly, MULT and SMUL are an optimized (integer) and generic (integer and/or floating point) versions of multiplication operators for 2 single inputs, respectively, and NSD is an optimization function for a concatenated NAMC STOD combination of instructions. In a fourth phase 1004d, a first QSV instruction is translated to QMSSD, thereby further retreating from the initial, optimized VALC operation.

Generally, the shadow array tends to stabilize for each particular processor. Furthermore, to the extent that a new branch into the code sequence occurs, that branch can be directly indexed to the location within the code sequence without adjusting the content of the shadow code array 1002; rather, the same offset into the code sequence of non-native code can be used, which is simply adjusted by the fact that the shadow-code array may have differently-sized byte elements.

Referring to FIGS. 9-10, it is noted that, by using the shadow code array and two-level parser arrangement of the present disclosure, only those code sequences that are in fact encountered are then parsed and translated, with corresponding instructions referenced in a shadow code array. This reduces the overhead of requiring complete pre-execution translation of non-native code. Furthermore, and referring to FIGS. 1-10 generally, it is noted that the adaptive nature of the present disclosure, alongside the two-stage interpreter architecture of that adaptive interpreter, provide a number of advantages over existing solutions. For example, and in particular with respect to translation of E-mode or other traditionally stack-based code, values that would otherwise be managed via stack push/pop mechanisms (and would typically be emulated as memory reads/writes) could be maintained in registers of a register-based architecture, and therefore would provide substantial performance improvement over other emulators that would be performance bound by the number of memory read/writes that are required.

The above specification, examples and data provide a complete description of the manufacture and use of the composition of the invention. Since many embodiments of the invention can be made without departing from the spirit and scope of the invention, the invention resides in the claims hereinafter appended.

1. A method of generating and executing a translated code stream using a processing module, the translated code stream corresponding to a translation of a plurality of non-native operators, the processing module executing on a computing system, the method comprising:
during interpreted execution of non-native code encountered by an interpreter, for a non-native operator included in a code sequence, selecting one or more native operators useable to perform a task defined at least in part by the non-native operator, wherein the one or more native operators are further selected based on a data type of non-native operands associated with the non-native operator;
storing the one or more native operators in a shadow code array in a memory of the computing system, the shadow code array associated with the processing module; and
executing the code sequence from the shadow code array, including executing the one or more native operators, thereby performing the task.

2. The method of claim 1, wherein the one or more native operators are selected from among a group of native operators that perform the task, the group of native operators differentiated from one another at least in part based on support for different data types.

3. The method of claim 2, wherein the different data types are selected from among a group of data types consisting of:
an integer type;
a floating point type;
a double-precision floating point type; and
a string type.

4. The method of claim 2, further comprising executing the code sequence a second time, wherein executing the code sequence the second time includes determining that a data type of an operand associated with a native operator in the shadow code array is mismatched to the native operator.

5. The method of claim 4, further comprising replacing the native operator in the shadow code array with a different native operator from among the group of native operators.

6. The method of claim 1, wherein the non-native code comprises emulation mode code.

7. The method of claim 1, wherein the interpreter executes on a processing unit of a computing system.

8. The method of claim 1, further comprising executing the non-native code using a plurality of processing units, wherein the shadow code array is associated with one of the plurality of processing units.

9. The method of claim 1, wherein, during subsequent interpreted execution of the code sequence, a mismatch is detected between a native operator referenced in the shadow code array and a second data type of an operand on which the native operator is to be executed, the second data type different from the data type.

10. The method of claim 9, further comprising replacing the native operator in the shadow code array with a version of the native operator that supports the data type and the second data type.

11. The method of claim 9, wherein the mismatch is detected as part of a native procedure representing execution of the native operator.

12. The method of claim 1, wherein storing the one or more native operators in the shadow code array comprises storing a pointer to a procedure corresponding to the one or more native operators in the shadow code array.

13. The method of claim 1, wherein selecting one or more native operators useable to perform a task defined at least in part by the non-native operator includes selecting, based on operation of a parser, one or more native operators that perform a task corresponding to the code sequence.

14. The method of claim 13, wherein the task corresponding to the code sequence corresponds to a sentence of in the non-native code detected by the parser.

15. An adaptive threaded virtual processing system executable on a computing system, the system comprising:
a processing unit;
a memory communicatively connected to the processing unit, the memory storing non-native instructions and data, a shadow code array, and an interpreter, the interpreter configured to, when executed by the processing unit, cause the computing system to perform a method of generating and executing a translated code stream, the translated code stream corresponding to a translation at least a portion of the non-native instructions, the method comprising:
during interpreted execution of non-native code, for a non-native operator included in a code sequence of the non-native instructions encountered by an interpreter, selecting one or more native operators useable to perform a task defined at least in part by the non-native operator, wherein the one or more native operators are further selected based on a data type of non-native operands associated with the non-native operator;
storing the one or more native operators in the shadow code array; and
executing the code sequence from the shadow code array, including executing the one or more native operators, thereby performing the task.

16. The system of claim 15, further comprising a plurality of processing units, and wherein the memory includes a plurality of shadow code arrays, each shadow code array associated with one of the processing units.

17. The system of claim 15, wherein the one or more native operators are selected from among a group of native operators that perform the task defined at least in part by the non-native operator on different operand types.

18. The system of claim 15, wherein the code sequence corresponds to a sequence of non-native instructions sequence each time the non-native instructions are encountered.

19. The system of claim 15, wherein the interpreter comprises a look-ahead left-to-right (LALR) parser.

20. The system of claim 15, wherein a non-native operator in the code sequence has a plurality of corresponding native operator equivalents, each of the plurality of corresponding native operator equivalents defined to operate on data of different data types.

21. The system of claim 15, wherein the non-native instructions and data are stored separately in the memory.

18. The system of claim 11, wherein the interpreter includes an operator interpretation phase and an execution phase.

22. The system of claim 21, wherein the operator interpretation phase and execution phase operate concurrently, with the operator interpretation phase populating one or more shadow code arrays and the execution phase executing native instructions from the one or more shadow code arrays.

23. A computer-readable storage medium having computer-executable instructions stored thereon which, when executed by a computing system, cause the computing system to perform a method of generating and executing a translated code stream corresponding to a translation of a plurality of non-native operators, the method comprising:
during interpreted execution of non-native code encountered by an operator interpretation phase of an interpreter, for each non-native operator included in a code sequence, selecting one or more native operators useable to perform a task defined by the non-native operator, wherein the one or more native operators are further selected based on a data type of non-native operands associated with the non-native operator,
storing the one or more native operators in a shadow code array in a memory of the computing system, the shadow code array associated with a processor of the computing system; and
executing the code sequence from the shadow code array via the processor by executing the one or more native operators, thereby performing the task.
